(19) United States
(12) Patent Application Publication
(10) Pub. No.: US 2013/0089153 A1
(43) Pub. Date: Apr. 11, 2013

(54) IMAGE COMPRESSION METHOD, AND ASSOCIATED MEDIA DATA FILE AND DECOMPRESSION METHOD

(71) Applicants: Sung-Wen Wang, Hsinchu County (TW); Chia-Chiang Ho, Hsinchu County (TW); Yi-Shin Tung, Hsinchu County (TW)

(72) Inventors: Sung-Wen Wang, Hsinchu County (TW); Chia-Chiang Ho, Hsinchu County (TW); Yi-Shin Tung, Hsinchu County (TW)

(73) Assignee: MStar Semiconductor, Inc., Hsinchu County (TW)

(21) Appl. No.: 13/644,487

(22) Filed: Oct. 4, 2012

Related U.S. Application Data
(60) Provisional application No. 61/543,886, filed on Oct. 6, 2011.

(30) Foreign Application Priority Data
Dec. 12, 2011 (TW) 100145855

(51) Int. Cl. H04N 7/26; G06K 9/36

(52) U.S. Cl. 375/240.25; 382/232; 382/233; 375/E07.027

(57) ABSTRACT

An image compression and decompression method is provided. The method includes steps of: dividing an original frame into a first portion and a second portion, scaling down the second porting to generate a shrunk portion, and recomposing the first portion and the shrunk portion to generate a recomposition frame and auxiliary information. The recomposition frame has a same size as that of the original frame. The recomposition frame is then encoded into frame data which is combined with the auxiliary information to generate a compressed data file.

This application claims the benefit of a provisional application Ser. No. 61/543,886, filed Oct. 6, 2011, and the benefit of Taiwan application Serial No. 100145855, filed Dec. 12, 2011 the subject matters of which are incorporated herein by reference.

### BACKGROUND OF THE INVENTION

1. Field of the Invention

The invention relates in general to an image compression method, and associated media data file and decompression method, and more particularly, to an image compression method capable of both appropriately decreasing a data amount, memory demands, and file sizes while maintaining image quality.

2. Description of the Related Art

Audio/video entertainment in mobile communication devices is a key feature. For example, selecting and playing a movie on a mobile phone or a tablet computer is a required application for this type of modern electronic equipment.

Media data files presented on a television or through a projector with sufficient image details, usually have a reasonably high resolution. The high resolution implies the media data files have corresponding large file sizes. However, the large-size media data files are prone to the drawbacks below when being played in a mobile communication device.

Image delay is a first possible issue. Massive media data files need a high-speed communication network to maintain smooth playback. However, the limited speed of mobile communication network causes image standstill and delay.

To play high-resolution images, a large-capacity storage medium is typically needed and such a storage medium is costly for a mobile communication device. Since the media data files with high resolution require more space to be stored, the storage hardware of a mobile communication device is more expensive than a common storage device.

Moreover, a total operable time of the mobile communication device is reduced because large-size media data files would consume more power for processing high-resolution images.

Therefore, there is a need for a solution of an effective image compression method that is capable of both reducing the size of a media data file and appropriately maintaining quality of each frame in the media data file.

### SUMMARY OF THE INVENTION

According to an embodiment of the disclosure, an image compression method is provided. The method includes steps of: dividing an original frame into a first portion and a second portion, scaling down the second portion to generate a shrunk portion, and recomposing the first portion and the shrunk portion to generate a recomposition frame. A size of the recomposition frame is the same as a size of the original frame.

According to another embodiment of the disclosure, a decompression method for a media data file is provided. The decompression method includes steps of: generating a recomposition frame and auxiliary information from the media data file, identifying a first portion and a shrunk portion in the recomposition frame according to the auxiliary information, scaling up the shrunk portion to generate a blurred portion, and recomposing the first portion and the blurred portion to generate a combined frame according to the auxiliary information.

According to another embodiment of the disclosure, a media data file is provided. The media data file is compliant to a predetermined file format, and includes a plurality of first objects and a plurality of second objects. The first objects include media data having a plurality recomposition frames. Each of the second objects includes subsidiary information and auxiliary information of a corresponding recomposition frame. The subsidiary information is utilized for decompressing the media data to generate the corresponding recomposition frame. The auxiliary information is utilized for identifying a first portion and a shrunk portion in the corresponding recomposition frame, and recording a scale down ratio of the shrunk portion.

According to yet another embodiment of the disclosure, a media data file is provided. The media data includes an audio/video file and metadata. The audio/video file is compliant to a predetermined file format, and provides a plurality of recomposition files and corresponding audio signals after being decoded. The metadata includes auxiliary information corresponding to the recomposition frames. The auxiliary information is utilized for identifying a first portion and a shrunk portion in the corresponding recomposition frame, and recording a scale down ratio of the shrunk portion.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a flow chart of an image compression method according to an embodiment of the disclosure.

FIG. 2 is an example of an original frame.

FIG. 3 show possible results generated after processing an original frame in Step 14.

FIG. 4 is a shrunk portion from generated by scaling down an uninterested portion.

FIG. 5A is an example of a recomposition frame.

FIG. 5B is an example of auxiliary information.

FIG. 6 is another example of a recomposition frame.

FIG. 7 is a flow chart of a decompression method according to an embodiment of the disclosure.

### DETAILED DESCRIPTION OF THE INVENTION

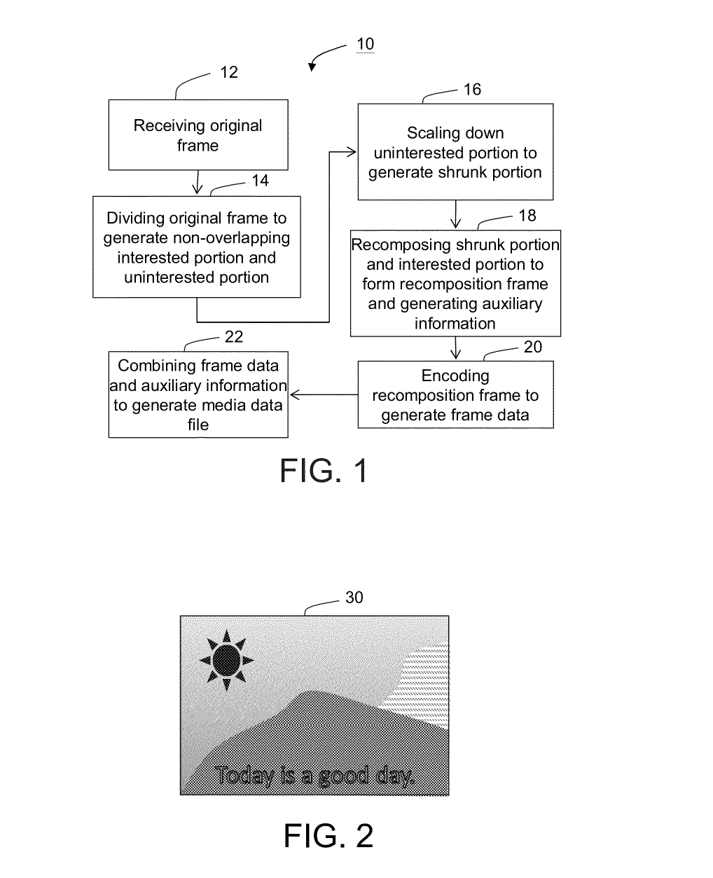

FIG. 1 shows an image compression method 10 according to an embodiment of the disclosure. The method 10 is suitable for a media data file and is applicable to an encoder. The media data file includes a plurality of original frames that are sequentially played. After having been processed by the image compression method 10, each original frame generates a corresponding recomposition frame. A recomposition frame is formed by an interested portion, an uninterested portion and auxiliary information. In this embodiment, the interested portion is defined as a first weighting portion, and the uninterested portion is defined as a second weighting portion, wherein the first weighting is greater than the second weighting. For example, the weighting of the subtitles may be increased while a user is demanding clear subtitles, and a lower part set by a certain ratio of an image, a white portion, or a high-contrast portion in an image is utilized as reference for determining whether the portion contains the subtitles. For another example, if a user requires clearness of specific objects (e.g., a human face, a human body, or an identified object), the weighting of the corresponding portion is increased.

Alternatively, a same-color block that is nearly white, located at a lower portion at a certain ratio of the image and extending horizontally, vertically, or towards a certain angle, is defined as a stroke region. The stroke region and a predetermined surrounding range are defined as the first weighting portion. In this embodiment, after determining the weighting portions, frame recomposition is performed. In the frame recomposition, pixels in the second weighting portion having a lower weighting are correspondingly reduced to a lower resolution. The reduction includes proportional scaling down, and non-proportional scaling down. The first weighting portion having a higher weighting is not scaled down, and is placed at an unprocessed original position in the frame. The second weighting portion is rearranged in the frame. Since the second weighting portion is scaled down, a blank portion that is neither the first weighting portion nor the second weighting portion is generated in the processed frame. The blank portion is filled by black or white as a background to reduce the information amount, or may be filled by another color level to similarly achieve the reduced information amount. In other words, the resolution of a user-interested portion is kept unchanged, whereas the resolution (relatively to the original frame) of the user-uninterested portion is decreased. Thus, in addition to being smaller than the original media data file to achieve the object of reducing a file size, the new media data file generated from compressing and encoding the recomposition frame also maintains the intactness of the interested portion in the original frame. Further, given that a compression rate for the interested portion is lower than a compression rate for the uninterested portion, the first weighting portion and the second weighting portion may be compressed and encoded by different compression rates, such that the resolution of the restored interested portion is higher than that of the restored uninterested portion.

In Step 12, the image compression method 10 receives an original frame from a media data file. FIG. 2 shows an example of an original frame 30 that is to be utilized for explaining results to be generated by some steps in the image compression method 10 shortly.

In Step 14, the original frame 30 is divided to generate at least one interested portion and at least one uninterested portion that are non-overlapping. Here, an interested portion generally refers to a portion with image quality that a user would not want to sacrifice, whereas an uninterested portion generally refers to a portion with image quality that can be sacrificed. For example, each original frame may be defined as a plurality of image blocks arranged in a matrix, each image block is substantially a square formed by 16×16 (or 8×8) pixels, and each pixel includes a plurality of subpixels corresponding to the three primary colors red, green, and blue. When an image block being checked satisfies a predetermined condition for the interested portion, the image block is categorized as the interested portion, or else the image block is categorized as the uninterested portion. The predetermined condition may be user defined. In Step 14, the image blocks are checked one after another. For example the image blocks located at a lower one-fourth of an original frame more or less contain subtitle information and are categorized as the interested portion, while the remaining image blocks are categorized as the uninterested portion. In another embodiment, an image block is categorized as the interested portion when the contrast of the image block exceeds a predetermined level, or else the image block is categorized as the uninterested portion. In yet another embodiment, an image block having a stroke region is categorized as the interested portion, or else the image block is categorized as the uninterested portion.

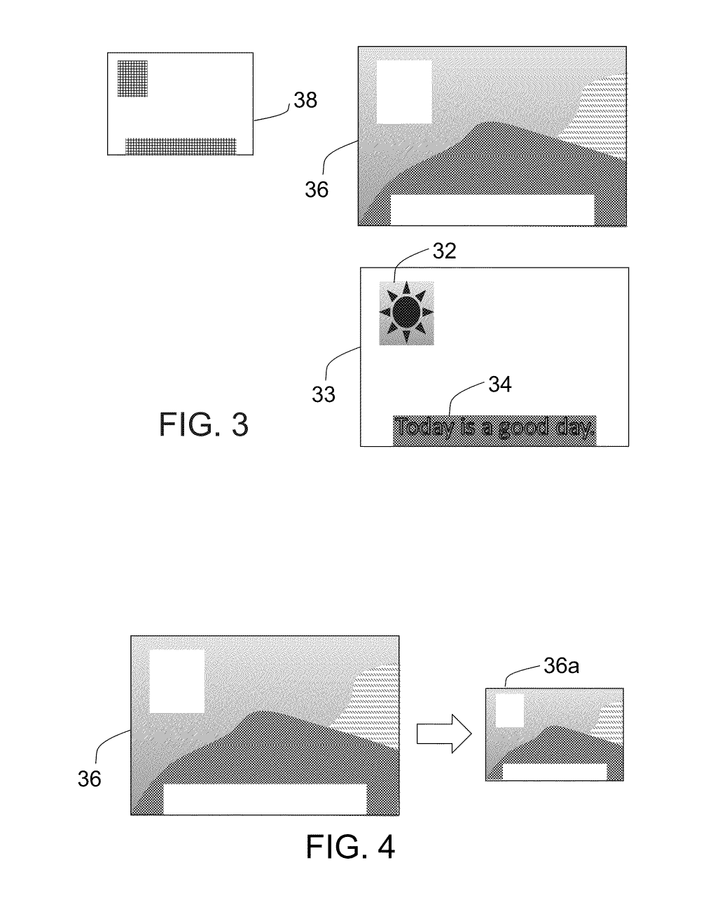

FIG. 3 shows some possible results of the original frame 30 processed by Step 14. In Step 14, an original position information image 38 is generated. In the original position information image 38, marked regions correspond to sections where the sun and subtitles are located in the original frame 30. For that the sections of the sun and subtitles have a larger contrast and/or contain strokes, those sections are categorized as the interested portion. Blank regions in the original position information image 38 correspond to the uninterested portion. As a result, the original frame 30 is divided into interested portions 32 and 34 and an uninterested portion 36. In FIG. 3, a frame 33 represents a frame formed by the interested portions 32 and 34.

Referring to FIG. 4, in Step 16, according to a scale down ratio, the uninterested portion 36 is scaled down to generate a shrunk portion 36a. The resolution of the shrunk portion 36a is lower than that of the uninterested portion 36.

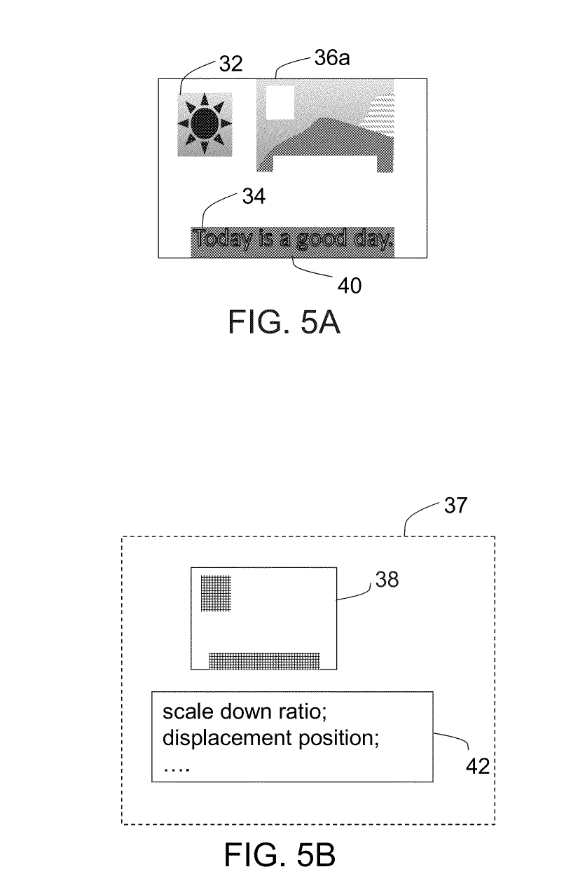

In Step 18, the shrunk portion 36a and the interested portions 32 and 34 are recomposed to form a recomposition frame, which has the same size as that of the original frame 30. FIG. 5A shows an example of a recomposition frame 40. In the recomposition frame 40, the positions and sizes of the interested portions 32 and 34 are the same as the original frame 30 and the shrunk portion 36a is located in a region unoccupied by the interested portions 32 and 34.

In Step 18, the interested portions 32 and 34 are duplicated and placed in a blank recomposition frame, and the relative positions and sizes of the interested portions are kept unchanged. According to a predetermined rule, a placement position at which the shrunk portion 36a is to be placed is determined. Then after the placement position determined, the shrunk portion 36a is placed in a blank region unoccupied in the recomposition frame to complete the recomposition frame 40. The rule for determining the placement position may be defined by user.

For example, the shrunk portion 36a can be located at all possible placement positions, with the possibilities overlapping the interested portions 32 and 34. When the shrunk portion 36a placed at a particular placement position does not overlap the interested portions 32 and 34 at all, or overlaps the interested portions 32 and 34 by a smallest possible area, the shrunk portion 36a is placed at this particular placement position to generate the final recomposition frame 40. As shown in FIG. 5A, in the final recomposition frame 40, the shrunk portion 36a does not overlap the interested portion 32 or 34.

In another embodiment, the determined placement position may make the corresponding recomposition frame have the smallest size after being compressed according to MPEG-4 standards. Each corresponding recomposition frame is generated corresponding to the shrunk portion 36a at each possible placement position; a corresponding frame data having a corresponding data size is also generated after being compressed according to MPEG-4 compression standards. Therefore, by identifying the smallest data size, the corresponding placement position can be obtained as the determined placement position.

In the process of generating the recomposition frame 40 in FIG. 5A, auxiliary information is also generated in Step 18. FIG. 5B shows an example of the auxiliary information which includes the original position information image 38 and recomposition information 42. As previously stated, the original position information image 38 includes the original position formation of the interested portion 32 or 34 and the uninterested portion 36. The recomposition information 42 includes a scale down ratio of the shrunk portion 36a, and the placement position of the shrunk portion 36a in the recomposition frame 40. It should be noted that the auxiliary information 37 is not limited to including the exemplary content in FIG. 5B, but may also include other user-desired information. To implement the recomposition information of the interested portion, during compression according to the MPEG format, a weighting parameter is added to a side or user-defined region in a compression unit (e.g., an 8×8-pixel or 16×16-pixel unit) of the interested portion to define whether the compression unit is categorized as the interested portion. The weighting parameter may be a binary value in 0 or 1, with the weighting parameter of the interested portion being defined as 1. When overlapping data occurs in the recomposition frame, the portions having the weighting parameter 1 are relocated to a blank portion that is neither the interested portion nor the uninterested portion 36, and are arranged along the blank portion according to a predetermined order (e.g., from left to right, from top to bottom). Thus, while restoring the frame, when a position occurs that has a weighting parameter 1 but is without pixel data, the pixel data is restored to the original positions of the interested portion according to the predetermined arrangement order.

In this embodiment, the interested portion placed at the original position in the recomposition frame is described as an example. It should be noted that, the interested portion may be placed at other positions during the recomposition. Taking MPEG for example, after converting data to the frequency domain, high-frequency components in continually arranged data are majority, such that the largest compression ratio can be obtained. Thus, during recomposition, image blocks ought to be placed according to a principle of continually arranging the data so that the recomposition frame is given a largest compression ratio during compression. When the position of the interested portion is adjusted during recomposition, the recomposition information 42 further includes the position information of the interested portion in the recomposition frame.

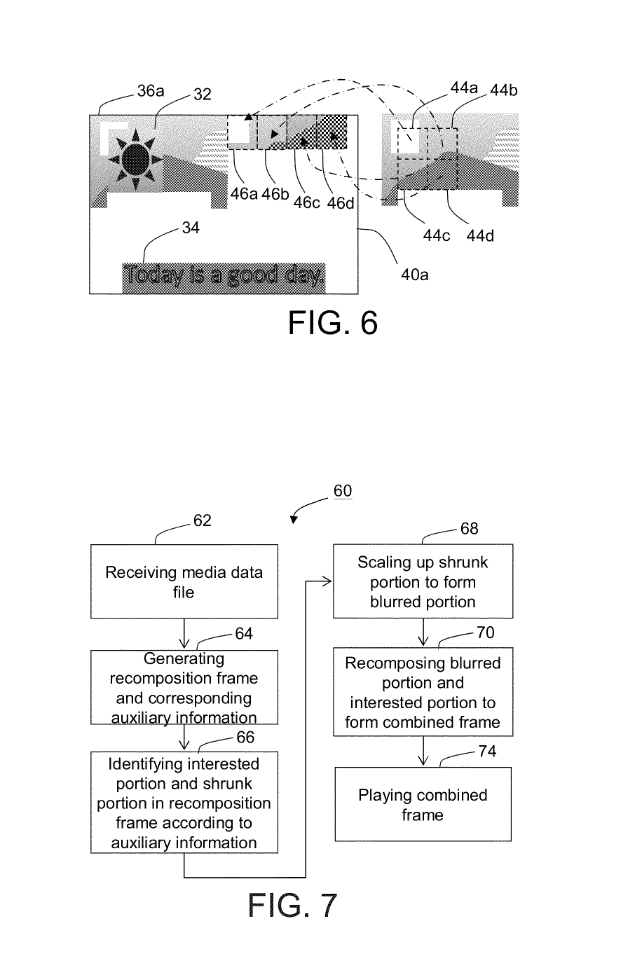

Once the placement position of the shrunk image 36a in a recomposition frame is determined, it is inevitable that the shrunk portion 36a may partially overlap the interested portion 32 or 34. To solve the issue of an overlap event, an appropriate scale down ratio parameter may be utilized. For example, when the width of the interested portion occupies one-third of that of the frame, the issue of an overlap event can be solved by selecting an appropriate scale down ratio that renders the width of the shrunk portion to be less than two-thirds of that of the frame. However, in a situation where a user demands clear subtitles and the white or high-contrast color blocks are utilized for determining the subtitles, it is possible that other high-contrast portions or white portions are determined as reserved portions having a high weighting, such that the final result of the interested portion may appear as irregularly-shaped. In such situation, it may be designed that the blocks of the shrunk portion are a complementary shape of the blocks of the interested portion, with the two types of blocks possibly interleaving each other. In other words, in a range of a same height and width, blocks of the interested portion and the shrunk portion may coexist. Thus, the issue of being incapable of solving the overlap through merely adjusting the width or height is effectively prevented. At this point, according to predetermined moving method and rule, an overlapping portion between the shrunk portion 36a and the interested portion 32 or 34 is placed in a region unoccupied by the shrunk portion 36a and the interested portions 32 and 34 in the recomposition frame. FIG. 6 shows another recomposition frame 40a. In the recomposition frame 40a, the placement position of the shrunk portion 36a is approximately at an upper left corner in a way that the shrunk 36a and the interested portion 32 partially overlap. Image blocks 44a to 44d indicate the overlapping portions in the shrunk portion 36a with the interested portion 32. Instead of being placed in a region occupied by the interested portion 32 in the recomposition frame 40a, the image blocks 44a to 44d are respectively relocated to areas 46a to 46d according to predetermined moving method and rule. In the recomposition frame 40a, the relocated portions are the overlapping portions in the shrunk portion 36a. In another embodiment, the relocated portions are the overlapping portions in the interested portion, and the predetermined moving method is performed according to an order of from left to right and from top to bottom.

In Step 20, the recomposition frame generated in Step 18 is encoded to generate a frame data. For example, according to MPEG-4 compression standards or other image coding protocols, the recomposition frame is encoded to generate the corresponding frame data.

In Step 22, the frame data and auxiliary information are combined to generate a media data file. In one embodiment, a plurality of frame data are stored in an MPEG-4 file, the auxiliary information corresponding to the frame data is stored in a metadata file, and the media data file generated in Step 22 is a combination of the MPEG-4 file and the metadata file. In another embodiment, the media data file generated in Step 22 is only an MPEG-4 file, whereas the auxiliary information is stored in a user-definable column in the MPEG-4 file.

Compared to the uninterested portion 36 in the original frame 30, the shrunk portion 36a in the recomposition frame 40 has a lower resolution, and the recomposition frame 40 further includes a relatively larger blank portion. It can be expected that, the media data file generated according to the recomposition file has a smaller size and is thus more suitable for playback of a mobile communication device.

The media data file generated in Step 22 may be transmitted to a mobile communication device via a wired or wireless network. Given that the mobile communication device is equipped with a corresponding decoding program or decoder, the combined frame that approximates the original frame can be generated and played according to the frame data and the auxiliary information in the media data file.

FIG. 7 shows a decompression method 60 for a decoder for processing the media data file generated in FIG. 1. The decompression method 60 is in principle a reverse operation of the image compression method 10 in FIG. 1.

In Step 62, a media data file is received. In one embodiment, the decompression method 60 is applied to a mobile phone, which receives the media data file via a wireless network.

In Step 64, according to a decoding protocol, a frame data in the media data file is decoded to generate a recomposition frame. For example, assuming the frame data is generated by compression according to the MPEG-4 compression standards, a recomposition frame is substantially restored and generated according to MPEG-4 decompression standards. Having undergone compression and decompression, the recomposition frame restored in Step 64 is substantially very similar to the recomposition frame generated in FIG. 1 if not entirely identical. In Step 64, corresponding auxiliary information is also obtained from the media data file.

In Step 66, according to the original position information image 38 and the recomposition information 42, an interested portion and a shrunk portion are identified from the recomposition frame generated in FIG. 64. For example, according to the original position information image 38 in FIG. 5B, the interested portions 32 and 34 can be identified from the recomposition frame 40 in FIG. 5A. Further, according to the recomposition information 42 in FIG. 5B, the shrunk portion 36a can be identified from the recomposition frame 40 in FIG. 5A.

Similarly, it can also be determined from the original position information image 38 and the recomposition information 42 that whether the recomposition frame 40 contains an overlapping portion. Provided that the predetermined moving method and rule for an overlap event in the image decompression method 10 are known, in Step 66, the interested portions 32 and 34 and the shrunk portion 36a can be identified/gathered from the recomposition frame 40.

In Step 68, the shrunk portion 36a is scaled up to form a blurred portion, which as the same size as that of the recomposition frame. Taking the shrunk portion 36a in FIG. 4 for example, having undergone scaling down and scaling up, the blurred portion generated in Step 68 is substantially the same as the uninterested portion 38 but has a lower resolution.

In Step 70, the blurred portion and the interested portion are recomposed to generate a combined frame according to the original position information image 38. The blurred portion is placed at a position corresponding to the uninterested portion. In general, the combined frame and a corresponding original frame have the same interested portion; however the blurred portion in the combined frame appears to be more blurry than the uninterested portion in the corresponding original frame. An intersection of the blurred portion and the interested portion may be processed to reduce or prevent image discontinuity resulted by a resolution difference. The combined frame generated in Step 70 is played in Step 74.

Although the resolution of the blurred portion is lower in the combined frame, the blurred portion, which contains information of less significance or less interest or is quite elusive from observations of a naked eye on a small-size screen of a tablet computer, is considered acceptable. For the interested portion that is more user-concerned, the resolution of the interested portion is maintained in the combined frame. Consequently, user perceptions are substantially unaffected when the combined frame is played in replacement of the original frame.

In one embodiment of the present invention, the media data file generated in the image compression method 10 in FIG. 1 is an MPEG-4 file compliant to an MPEG-4 file format. An MPEG-4 file includes several objects, each of which is referred to as an atom. For example, the real media data in the recomposition frame 40 in FIG. 5A is stored in a media data atom. A media data atom is commonly referred to as an MDAT atom. Subsidiary information including the compression method, track type and time stamp of the recomposition frame 40 is stored in a movie atom, which is commonly referred to as a MOOV atom. The auxiliary information 37 corresponding to the recomposition frame 40 is stored in a user-definable user data atom in the MOOV atom. Alternatively, the subsidiary information and auxiliary information can be appended after the MPEG file. In another embodiment, when the recomposition frame 40 is compressed according to the H.264 standard, the auxiliary information and subsidiary information can be appended after each transmitted frame (e.g., a frame 1+first auxiliary information, a frame 2+second auxiliary information . . . etc). The auxiliary information is quite critical in the present disclosure. Without the auxiliary information, only the recomposition frame 40 can be restored but the original frame cannot be restored by the decompression method. The above approaches for appending the auxiliary information can be simultaneously utilized instead of utilizing one approach at a time. Alternatively, the auxiliary information may be simultaneously appended to the foregoing positions to minimize the possibility of also losing the auxiliary information in the event of a frame loss or a packet loss.

In another embodiment of the disclosure, the media data file generated by the media compression method 10 in FIG. 1 is a combination of an MPEG-4 file and a metadata file. The MPEG-4 file stores the real media data and the corresponding subsidiary information of all the recomposition frames. That is, after decompressing the MPEG-4 file according to the MPEG-4 decompression standard, audio signals corresponding to a plurality of recomposition frames can be obtained without obtaining the corresponding auxiliary information. The metadata file stores the auxiliary information and time stamp of all the recomposition frames. The time stamp allows a decoder to quickly locate the corresponding auxiliary information when processing a recomposition frame.

In the embodiment in FIG. 1, the image compression method 10 only divides the original frame into two parts—the interested portion and the uninterested portion. However, it should be noted that the present disclosure can also divide the original frame into more than two parts. For example, in another embodiment of the disclosure, the original frame is divided into three parts—an interested portion, an uninterested portion, and an extremely uninterested portion. The uninterested portion and the extremely uninterested portion may be scaled down by different scale down ratios, and then altogether recomposed with the interested portion into a recomposition frame. At this point, the auxiliary information may include the original position information image of the interested, uninterested portion and extremely uninterested portions, the scale down ratio and placement position of the uninterested portion, the scale down ratio and placement position of the extremely uninterested portion, . . . etc.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image compression method, comprising:
dividing an original frame into a first portion and a second portion;
scaling down the second portion to generate a shrunk portion; and
recomposing the first portion and the shrunk portion to generate a recomposition frame.

2. The method according to claim 1, wherein the recomposing step comprises:
determining a placement position of the shrunk frame in the recomposition frame according to a rule; and
wherein, the placement position renders a smallest area of an overlap portion between the shrunk portion and the first portion.

3. The method according to claim 1, further comprising:
determining a placement position of the shrunk frame in the recomposition frame according to a rule; and
encoding the recomposition frame to generate a frame data;
wherein, the placement position renders a smallest area of an overlap portion between the shrunk portion and the first portion.

4. The method according to claim 1, wherein the recomposing step comprises:
determining a placement position of the shrunk frame in the recomposition frame; and
when the placement position renders an overlap event between the shrunk portion and the first portion, placing the shrunk portion or an overlap portion in the first portion in a region unoccupied by the first portion and the shrunk portion in the recomposition frame according to a predetermined method.

5. The method according to claim 1, wherein the recomposing step comprises:
placing the first portion in the recomposition frame; and
placing the shrunk portion in a region unoccupied by the first portion in the recomposition frame.

6. The method according to claim 1, wherein the original frame comprises a plurality of same-sized image blocks, each of the image blocks comprises a plurality of pixels, and the dividing step categorizes a corresponding image block as the first portion or the second portion according to a predetermined rule.

7. The method according to claim 6, wherein the predetermined rule is a contrast relativity of the corresponding image block.

8. The method according to claim 6, wherein the predetermined rule is whether the corresponding image block contains a stroke portion.

9. The method according to claim 1, further comprising:
encoding the recomposition frame to generate a frame data; and
generating a media data file, the media data file comprising the frame data and auxiliary information, the auxiliary information comprising an indication of a placement position of the shrunk portion in the recomposition frame.

10. The method according to claim 9, wherein the auxiliary information comprises a scale down ratio of the shrunk portion.

11. The method according to claim 9, wherein the auxiliary information comprises original position information of the first portion and the second portion.

12. A media data file, compliant to a predetermined file format, comprising:
a plurality of first objects, comprising media data of a plurality of recomposition frames;
a plurality of second objects, each second object comprising subsidiary information and auxiliary information of a corresponding recomposition frame of the recomposition frames;
wherein, the subsidiary information is utilized for decompressing the media data file to generate the corresponding recomposition frame; the auxiliary information is utilized for identifying a first portion and a shrunk portion in the corresponding recomposition frame, and for recording a scale down ratio of the shrunk portion.

13. The media data file according to claim 12, wherein the predetermined file format is an MPEG-4 file format, and the auxiliary information is stored in a user-definable user data atom in a movie atom.

14. A media data file, comprising:
a video/audio file, compliant to a predetermined file format, providing a plurality of recomposition frames and corresponding audio signals after being decoded; and
metadata, comprising auxiliary information and time stamps corresponding to the recomposition frames;
wherein, the auxiliary information is utilized for identifying a first portion and a shrunk portion in the corresponding recomposition frame, and for recording a scale down ratio of the shrunk portion.

15. The media data file according to claim 14, wherein the predetermined file format is an MPEG-4 file format.

16. A decompression method for a media data file, comprising:
generating a recomposition frame and auxiliary information from the media data file;
identifying a first portion and a shrunk portion in the recomposition frame according to the auxiliary information;
scaling up the shrunk portion to generate a blurred portion; and
recomposing the first portion and the blurred portion to generate a combined frame according to the auxiliary information.

17. The decompression method according to claim 16, wherein the auxiliary information comprises a scale down ratio, and the scaling up step generates the blurred portion according to the scale down ratio.

18. The decompression method according to claim 16, wherein the auxiliary information comprises original position information of the first portion and the blurred portion.

19. The decompression method according to claim 16, wherein the recomposition frame comprises a blank portion.
